(19) United States
(12) Patent Application Publication
(10) Pub. No.: US 2011/0113576 A1
(43) Pub. Date: May 19, 2011

(54) TOOTHBRUSH WITH MOVABLE HEAD

(76) Inventor: Samuel L. Yankell, Moorestown, NJ (US)

(21) Appl. No.: 12/620,282

(22) Filed: Nov. 17, 2009

(51) Int. Cl. A46B 9/04; A61C 17/00

(52) U.S. Cl. 15/167.2; 433/216

(57) ABSTRACT

A toothbrush and method of brushing the teeth of a user. The toothbrush comprises a toothbrush handle having one or more toothbrush heads movable with respect to the handle. There are bristles provided on the toothbrush head or heads and those bristles can be along a single plane or may be along a plurality of planes. The flexibility and movability between the toothbrush handle and the toothbrush head allows the user to brush the teeth in a smooth, even pattern across the teeth, that is, the toothbrush handle can be used to manipulate the toothbrush head from the rear of one side of the teeth to the rear of the other side of the teeth without removing the toothbrush head from the mouth of the user. As such, users with difficulty carrying out complex manipulation of the toothbrush handle can still fully brush the teeth.

### BACKGROUND

The present invention relates to a toothbrush for cleaning the teeth of a person and, more particularly to a toothbrush having a movable head that improves the cleaning and efficiency of the cleaning process.

In general, there are many designs of toothbrushes that have been proposed and considered to carry out the cleaning of a person's teeth. With such designs, a common bond is that the toothbrushes are designed to clean the teeth in stages, that is, the toothbrush is used to clean the teeth along both sides of the jaw as well as the front of the teeth in individual stages and the toothbrush is normally required to be removed from the mouth in transitioning from one stage to another.

Each of the individual steps in brushing the teeth requires a certain manipulation of the toothbrush including periodic removal of the toothbrush from the mouth, a repositioning or reorientation of the toothbrush and a reinsertion of the toothbrush into the mouth. The periodic and continuous removal, reorientation and reinsertion of the toothbrush from and into the mouth interrupts the smooth motion in brushing the teeth.

As a result, there is a real problem with elderly or incapacitated persons having limited motion and manipulation of the hands and fingers such that it is very difficult to brush one side of the teeth, remove the toothbrush from the mouth, reorient the toothbrush to a different position and then reinsert the toothbrush into the mouth to continue brushing another portion of the teeth. That manipulation of the toothbrush is difficult and, as such, the elderly or incapacitated persons may carry out inadequate brushing of the teeth rather than go through the difficult process.

It would therefore be advantageous to have a toothbrush capable of brushing the teeth at both sides of the jaw as well as at the front of the jaw in one smooth, uniform continuous movement.

### SUMMARY OF THE INVENTION

Accordingly, the present invention overcomes the difficulties and problems associated with the prior art toothbrushes by providing a toothbrush that has a toothbrush handle and a toothbrush head that is movable with respect to the toothbrush handle. The movement between the toothbrush head and the toothbrush handle allows the toothbrush head, having bristles affixed thereto, to flex as the user brushes the teeth.

Accordingly, in the use of the present toothbrush, the user can move the toothbrush head in a very smooth and simple manner to progress the toothbrush head from the rear of one side of the teeth past the front of the teeth and to the rear of the other side of the teeth without removing the toothbrush head from the mouth of the user. In effect, the user need not remove the toothbrush head from the mouth and carry out any complex manipulations of the toothbrush handle and yet can access and thus clean all of the teeth of the user.

The flexible connection providing the movability of the toothbrush head with respect to the toothbrush handle can be by a variety of means, one of which may be a pin that connects between the toothbrush head and the toothbrush handle to allow the toothbrush head to rotate in a plane and another means can be by providing a flexible molded connection between the toothbrush head and the toothbrush handle, an example of which is a living hinge.

In the exemplary embodiments, there may be multiple toothbrush heads that are movably affixed to the toothbrush handle and there may be a single set of bristles or a plurality of sets of bristles in different planes.

These and other features and advantages of the present invention will become more readily apparent during the following detailed description taken in conjunction with the drawings herein.

### BRIEF DESCRIPTION OF THE DRAWINGS

FIG. 1 is a side view of an exemplary embodiment of the toothbrush of the present invention;

FIG. 2 is a side view of a further exemplary embodiment of the toothbrush of the present invention;

FIGS. 3A-3C are schematic views illustrating a method of brushing the teeth using the toothbrush of FIG. 2;

FIGS. 4A-4C are schematic views of a still further exemplary embodiment of the toothbrush of the present invention; and

FIG. 5 is a schematic view illustrating a method of brushing the teeth using the toothbrush of FIGS. 4A-4C.

### DETAILED DESCRIPTION OF THE INVENTION

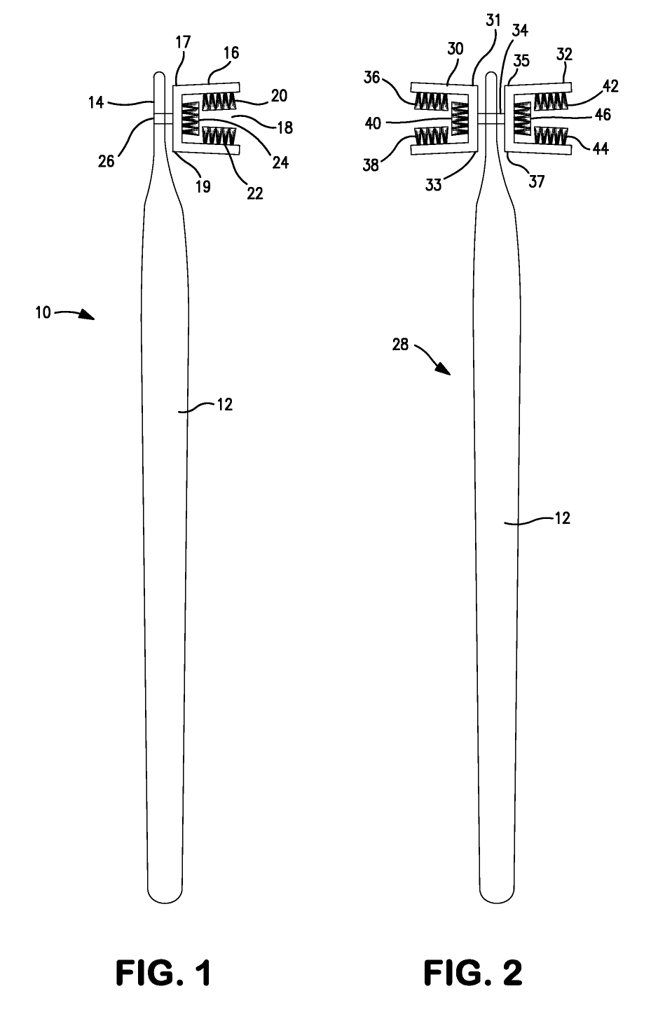

Referring now to FIG. 1, there is shown a side view of a toothbrush 10 constructed in accordance with the present invention. As can be seen, the toothbrush 10 comprises a handle 12 that is adapted to be grasped by the user for carrying out the brushing of the teeth. The handle has a distal end 14 that is intended to be inserted into the user's mouth in carrying out the cleaning process and there is a toothbrush head 16 affixed at or proximate to the distal end.

As can be seen, in the exemplary embodiment of FIG. 1, the toothbrush head 16 is generally U-shaped or rectangular shaped with an open end 18. The toothbrush head can be comprised of plastic or other inexpensive moldable materials and there are three sets of bristles, that is, a set of side bristles 20 and 22 and a set of top bristles 24. The sets of bristles can be conventional bristles, and can be made of materials, such as nylon, that are common in the construction of bristles.

In the FIG. 1 embodiment, the toothbrush head 16 is movably affixed to the toothbrush handle 12 by means of pin 26 such that the toothbrush head 12 can pivot in a plane about the pin 26. Other methods and means can, of course, be used to movably affix the toothbrush head 16 to the handle 12.

As can now be seen, and which will later become clear, in the use of the toothbrush of FIG. 1, the toothbrush head 16 is placed over teeth of either the upper set of teeth of the lower set of teeth such that the sets of side bristles 20 and 22 contact and clean the inner and outer surfaces of the teeth while the upper set of bristles 24 contacts and cleans the biting surfaces of the teeth. As such, by simply moving the toothbrush 10 along the teeth, either the upper set or lower set, the teeth are cleaned along all three outer surfaces. The particular use and function of the movable affixation of the toothbrush head 16 to the handle 14 will be later explained. Living hinges can also be used at the junctions 17, 19 of the side bristles 20, 22 and the top bristles 24 to allow some flexing of the side bristles 20, 22 as the teeth are brushed.

Turning now to FIG. 2, there is shown a side view of a toothbrush 28 that is a further exemplary embodiment of the present invention. As can be seen in FIG. 2, there are two toothbrush heads 30, 32 movably affixed to the handle 12 and there can be a common pin 34 that connects the two toothbrush heads 30, 32 so that each can rotate in a plane and are oppositely disposed with respect to each other. Again each of the heads 30, 32 has sets of bristles, that is, the toothbrush head 30 has sets of side bristles 36, 38 and a set of top bristles 40 while the toothbrush head 32 has sets of side bristles 42, 44 and a set of top bristles 46.

Again, living hinges can be used at the junctions 31, 33 of the side bristles 36, 38 and the top bristles 40 and also at the junctions 35, 37 of the side bristles 42, 44 and the top bristles 46 to allow flexibility between those bristles.

As such, by simply moving the toothbrush 28 along the teeth, all three outer surfaces of the upper and lower sets of teeth can be simultaneously cleaned. Again, the actual method of carrying out that cleaning will be later explained.

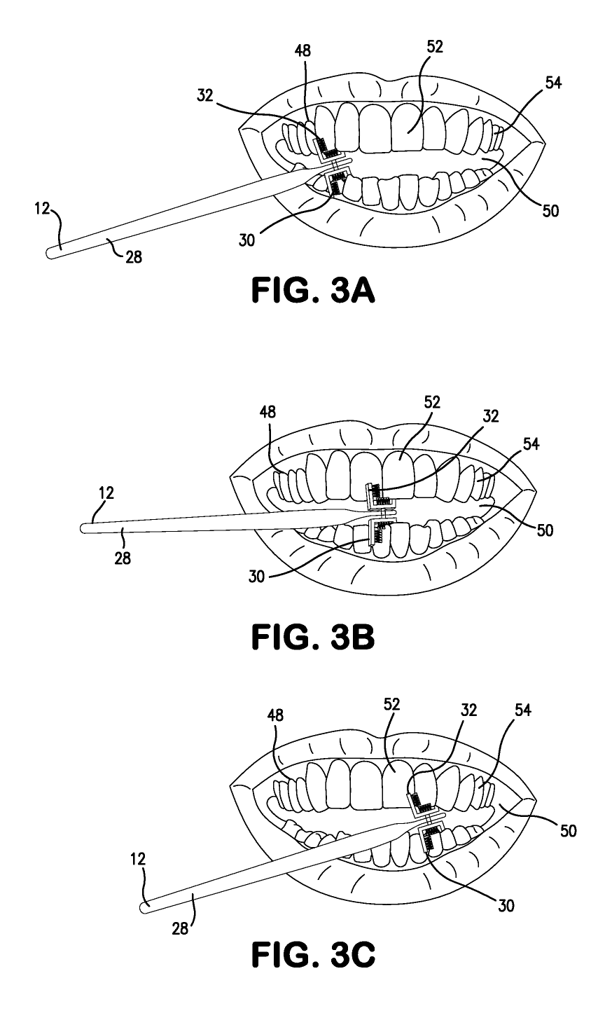

Turning then to FIGS. 3A-3C, there is shown perspective views illustrating the use of the toothbrush 28 in cleaning the teeth of a user. While the FIGS. 3A-3C illustrate the toothbrush 28 having the double sets of toothbrush heads 30, 32, it can be seen that the toothbrush 10 of FIG. 1 having a single toothbrush head 16 can be used in the same manner.

As such, in FIG. 3A, the toothbrush 28 is shown with the toothbrush heads 30, 32 located at the right side 48 of the user's mouth 50, in FIG. 3B the toothbrush heads 30, 32 are located generally at the front 52 of the user's mouth 50 and in FIG. 3C, the toothbrush heads 30, 32 are located at the left side 54 of the user's mouth 50.

To traverse the toothbrush heads 30, 32 from the right side 48 to the left side 54, the toothbrush heads 30, 32 need not be removed from the mouth of the user but due to the movable mounting of the toothbrush heads 30, 32 to the handle 12, the toothbrush heads 30, 32 can simply be slid along the teeth to traverse the teeth from the right side 48 to the left side 54.

As shown in FIG. 3A, to start the brushing process, the toothbrush heads 30, 32 are inserted at the back of the right side 48 of the user's mouth 50. At that point the handle 28 is pulled outwardly with respect to the mouth 50 and the toothbrush heads 30, 32 move forwardly toward the front 52 of the mouth 50. Upon reaching the front 52 of the mouth 50, the handle 28 can be used to slide the toothbrush heads 30, 32 along the front 52 in the direction toward the left side 54 of the mouth 50.

At some point in that travel, the toothbrush handle 28 is pushed inwardly toward the back of the mouth 50 to force the toothbrush heads 30, 32 rearwardly to the back of the left side 54 of the mouth 50. Accordingly, the overall movement of the toothbrush 28 is fluid, smooth and there is very little manipulation of the toothbrush handle 12 to fully brush the upper teeth and the lower teeth from the right side 48 all the way to the left side 54 without the need to remove the toothbrush from the mouth or carry out any complex manipulations.

Basically, as can be seen, the movement of the toothbrush head, when using the toothbrush 10 of FIG. 1 is in a plane that is parallel to a plane formed by the upper surfaces of the teeth being brushed. In the case of the toothbrush 28 of FIG. 2, having two toothbrush heads, 30, 32, the movement of the heads 30, 32 is in a plane also parallel to the upper surfaces of the upper and lower teeth or the gap therebetween.

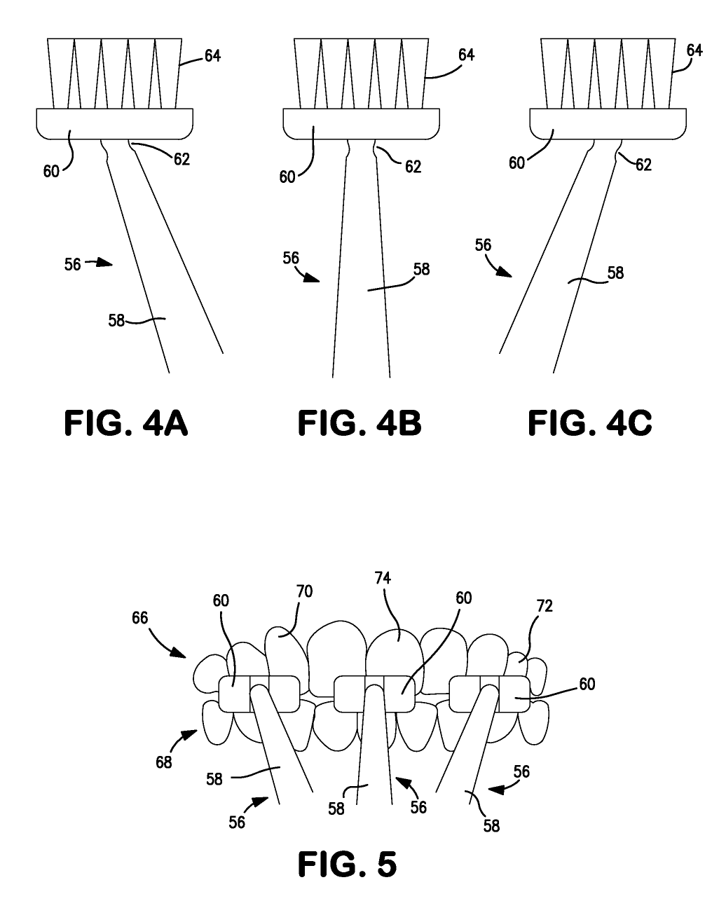

Turning now to FIGS. 4A-4C, there is shown schematic views of a further exemplary embodiment of the toothbrush 56 of the present invention. In this embodiment, the handle 58 is molded in conjunction with the toothbrush head 60 such that the toothbrush handle 58 and toothbrush head 60 can be a one-piece molded construction. The movable connection between the toothbrush handle 58 and the toothbrush head 60 can be seen as a flexible junction 62 proximate to the toothbrush head 60.

As can be seen, there may be a narrowed portion of the toothbrush material at the flexible junction 62, known as a living hinge, however, if the molded material of the toothbrush itself is sufficiently flexible and a small cross sectional area is present, the use of a living hinge or narrowed portion is not needed. The flexing must be relatively easy to accomplish and be carried out by a user having limited manipulative skills.

Thus, with the embodiment of FIGS. 4A-4C, the toothbrush handle 58 can move side to side with respect to the toothbrush head 60 on which the bristles 64 are provided.

Turning finally to FIG. 5, there is shown a schematic view illustrating the brushing of the upper teeth 66 and the lower teeth 68 as the toothbrush head 60 of toothbrush 56 moves from one side to the other. Accordingly, assuming the user starts on the right side 70 of the teeth and progresses smoothly from that right side 70 to the left side 72 via the front 74 of the teeth, the toothbrush handle 58 can readily manipulated without removing the toothbrush head 60 from the mouth of the user and again, the toothbrush 56 can be started at the rear teeth on the right side 70 where the toothbrush handle 62 is pulled outwardly, moved laterally across the front 74 and then pushed inwardly to the rear of the left side 72 such that the teeth are brushed in one smooth motion without any complex manipulations of the toothbrush handle 58.

Those skilled in the art will readily recognize numerous adaptations and modifications which can be made to the toothbrush of the present invention which will result in an improved toothbrush and improve the brushing procedures, yet all of which will fall within the scope and spirit of the present invention as defined in the following claims. Accordingly, the invention is to be limited only by the following claims and their equivalents.

1. A toothbrush for brushing the teeth of a person, the toothbrush comprising:
a toothbrush handle;
at least one toothbrush head having at least one set of bristles, the at least one toothbrush head movably affixed to the handle by means of a flexible junction so as to freely move with respect to the toothbrush handle as the toothbrush traverses along the teeth of a person, the toothbrush head, the flexible junction and the toothbrush handle being a one-piece molded construction.

2. The toothbrush as defined in claim 1 wherein the flexible junction is a living hinge.

3-4. (canceled)

5. The toothbrush as defined in claim 1 wherein the at least one toothbrush head has a plurality of sets of bristles

6. The toothbrush as defined in claim 5 wherein the at least one toothbrush head has three sets of bristles that are adapted to engage the biting surface of the teeth and at least one side.

7. The toothbrush as defined in claim 6 wherein junctions between the three sets of bristle are living hinges.

8. The toothbrush as defined in claim 1 wherein the at least one toothbrush head comprises two toothbrush heads oppositely disposed to each other.

9. The toothbrush as defined in claim 8 wherein each of the two toothbrush heads has a plurality of sets of bristles.

10. The toothbrush as defined in claim 9 wherein each of the two toothbrush heads has three sets of bristles in three planes.

11. The toothbrush as defined in claim 10 wherein each of the three sets of bristles are joined together by means of living hinges.

12. (canceled)

13. A method of cleaning the sides and front of the teeth of a person comprising the steps of:
providing a toothbrush having a toothbrush handle and having at least one toothbrush head movably affixed to the toothbrush handle, the toothbrush handle and the at least one toothbrush head being formed as a one-piece molded construction having a flexible junction therebetween, the at least one toothbrush head having at least one set of bristles,
introducing the toothbrush into the mouth of a person to engage the bristles with the teeth of the person,
moving the toothbrush head along the teeth of the person by manipulating the toothbrush handle while allowing the toothbrush head to move with respect to the toothbrush handle by means of the flexible junction to allow the teeth to be cleaned without removing the toothbrush head from the mouth of the person.

14. The method of claim 13 wherein the step of moving the toothbrush head along the teeth comprises initially pulling the handle to move the toothbrush outwardly with respect to the teeth of the person, next, moving the toothbrush head laterally across the front of the teeth and then pushing on the handle to move the toothbrush head rearwardly with respect to the teeth of the person.

15. The method of claim 13 wherein the step of providing a toothbrush having at least one toothbrush head comprises providing a toothbrush having two toothbrush heads oppositely disposed on the handle.

16. The method of claim 13 wherein the step of providing a toothbrush having a handle and having at least one toothbrush head movably affixed to the handle comprises providing a toothbrush having at least one toothbrush head having three sets of bristles in different planes.

17. The method of claim 13 wherein the step of providing a toothbrush having a handle and having at least one toothbrush head movably affixed to the handle comprises providing a toothbrush having at least one toothbrush head having three sets of bristles in different planes with the sets of bristles joined together by means of living hinges.

18. The method of claim 15 wherein the step of providing a toothbrush having a handle and having two toothbrush heads each having three sets of bristles in different planes.

19. The method of claim 15 wherein the step of moving the toothbrush heads along the teeth of the person comprises manipulating the toothbrush handle to move the toothbrush heads in a plane parallel to the plane of the space between the upper and lower teeth.

20. The method of claim 18 wherein the step of moving the at least one toothbrush head along the teeth of the person by manipulating the handle comprises moving the toothbrush heads to simultaneously clean three surfaces of both the upper and lower set of teeth.
